(19) United States
(12) Patent Application Publication
(10) Pub. No.: US 2026/0366468 A1
(43) Pub. Date: Nov. 19, 2026

(54) CYLINDER ASSEMBLY AND ASSOCIATED VEHICLE

(71) Applicant: VOLVO TRUCK CORPORATION, Göteborg (SE)

(72) Inventor: Frank LÖFSKOG, Olofstorp (SE)

(73) Assignee: VOLVO TRUCK CORPORATION, Göteborg (SE)

(21) Appl. No.: 19/675,644

(22) Filed: May 13, 2026

(30) Foreign Application Priority Data
May 14, 2025 (EP) 25176475.9

(51) Int. Cl. F02F 1/16; F01P 3/02; F02F 1/14

(52) U.S. Cl. CPC F02F 1/16; F01P 3/02; F02F 1/14; F01P 2003/021

(57) ABSTRACT

A cylinder assembly, for an internal combustion engine, has a cylinder block, comprising an internal surface delineating a bore centered on a cylinder axis, a cylinder liner, received in the cylinder block, comprising an outer surface, oriented radially outwards relative to the cylinder axis so as to face the internal surface of the cylinder block, and an inner surface, oriented radially inwards, a cooling element, arranged inside the cylinder liner, between the outer surface and the inner surface, and a cooling circuit, delineated by the internal surface of the bore and the outer surface of the cylinder liner.

### TECHNICAL FIELD

The disclosure relates generally to internal combustion engines. In particular aspects, the disclosure relates to a cylinder assembly for an internal combustion engine and an associated vehicle. The disclosure can be applied to heavy-duty vehicles, such as trucks, buses, and construction equipment, among other vehicle types. Although the disclosure may be described with respect to a particular vehicle, the disclosure is not restricted to any particular vehicle.

### BACKGROUND

The movement of a crankshaft of an internal combustion engine comes from the movement of several pistons, translationally sliding in respective cylinder blocks. Each piston is usually linked to the crankshaft by a connecting rod for transforming the translation of the piston into the rotation of the crankshaft. The translation of the piston comes from the combustion of a mixture of fuel and oxidizer. Such cylinder blocks are often garnished with a cylinder liner. In this case, the liner is inserted inside the cylinder block, or motor block, and the piston is in contact with the liner rather than with the cylinder block.

A cylinder liner allows using a material different from the one of the cylinder block. This allows using a cylinder liner made of a material ensuring a proper fatigue and thermal resistance and a low-friction with the piston. In addition, maintenance is rendered easy because the cylinder liner can be replaced instead of machining the cylinder block itself.

Between the cylinder liner and the cylinder block may be arranged a cooling circuit, where a coolant flows. This enables cooling down the cylinder liner, which receives heat from the friction and from the combustion that occurs nearby. However, if the cylinder liner is connected to the cylinder block at its top end, there is no room between the cylinder block and the cylinder liner at the top end to arrange a part of the cooling circuit at the top of the cylinder, close to where the combustion occurs.

If the cylinder assembly is not cooled, especially at the top where the combustion occurs, hotspots may appear at the top of the cylinder liner and/or cylinder block and in the piston. The piston often has a compression ring to ensure tightness of the combustion chamber. In case of overheating, the compression ring might deteriorate.

In addition, overheating of the top end of the cylinder liner, that can cause flatness defect which can reduce effectiveness of the cylinder head gasket of the internal combustion engine.

Until now, a solution for avoiding overheating of the compression ring is to provide a sealing ring that is below the flange of the cylinder liner, where a cooling circuit can be arranged between the cylinder liner and the cylinder block. Ideally the upper compression ring (if multiple) on the piston has its top most position below the flange of the cylinder liner. This means there often is a distance between the top of the piston and the compression ring (sometimes referred to as the piston top land height) to secure cooling of the compression ring. This creates a gap between the compression ring, the piston and the top of the cylinder liner. This gap, even narrow, has a mixture of fuel and oxidizer seeping into, which causes fuel waste and potential unwished combustion.

It is an object of the present invention to provide a cylinder assembly allowing a more efficient cooling of the top end of the cylinder liner than what is disclosed in the prior art, allowing a reduction of gap volume between compression ring, piston and cylinder liner.

### SUMMARY

A first aspect of the disclosure concerns a cylinder assembly, for an internal combustion engine, comprising:
a cylinder block, comprising an internal surface delineating a bore centered on a cylinder axis,
a cylinder liner, coaxially received in the cylinder block and comprising an upper end, crossed by the cylinder axis, a lower end, crossed by the cylinder axis, an outer surface, oriented radially outwards relative to the cylinder axis so as to face the internal surface of the cylinder block, and an inner surface, oriented radially inwards to guide a piston in a reciprocating translation along the cylinder axis, with respect to the cylinder block, between the upper end and the lower end,
a cooling element, arranged inside the cylinder liner, between the outer surface and the inner surface, and
a cooling circuit, delineated by the internal surface of the bore and the outer surface of the cylinder liner, the cooling circuit being configured to allow a coolant to flow inside the cooling circuit,
wherein the cooling element extends axially, with respect to the cylinder axis, from an upmost portion of the cooling element to a lowest portion of the cooling element, the upmost portion being closer to the upper end of the cylinder liner than the lowest portion, wherein the lowest portion is located at same height, taken along the cylinder axis, as a part of the cooling circuit,
wherein the cylinder assembly comprises a coolant passage connecting the cooling circuit to the cooling element and wherein the coolant passage is formed in the cylinder liner and oriented radially relative to the cylinder axis.

A technical benefit may include a better cooling of the cylinder liner, and of the piston. The cooling effect is indeed obtained inside the liner. At the same time, the cooling circuit conveniently ensures cooling of the liner and the cylinder block. Another technical benefit may include an improved cooling of the liner by transferring heat from a coolant flowing in the cooling circuit that is outside of the liner, to the cooling element inside the liner. Yet another technical benefit may include improving compactness of the cylinder assembly by using same coolant for both the cooling circuit and cooling element. An additional technical benefit may include enabling coolant to flow with reduced head loss.

Optionally in some examples, including in at least one preferred example, the cooling circuit has an annular shape, coaxial with the cylinder axis.

A technical benefit may include a radially homogeneous cooling of the outer surface of the cylinder liner, since both the cylinder liner and the cooling circuit have a coaxial annular shape.

Optionally in some examples, including in at least one preferred example, the cooling element is located at the upper end of the cylinder liner.

A technical benefit may include an improved cooling of the upper end of the liner, which requires most of the cooling, since the combustion occurs at the upper end.

Optionally in some examples, including in at least one preferred example, the cooling element has an annular shape, coaxial with the cylinder axis.

A technical benefit may include a radially homogeneous cooling of the liner at a specific height along the cylinder axis, where the cooling element is arranged.

Optionally in some examples, including in at least one preferred example, the cooling element is a cooling gallery configured to allow a coolant to flow inside.

A technical benefit may include improving the cooling at cooling element’s height, by using a coolant within the liner, at a height where it is not possible to arrange the cooling circuit without mentioned cooling element.

Optionally in some examples, including in at least one preferred example, the cylinder assembly comprises an even number of coolant passages, each coolant passage having corresponding coolant passage opposite with respect to the cylinder axis.

A technical benefit may include more efficient cooling by the cooling element, by ensuring constant renewal of the coolant in the cooling element. The coolant may indeed enter the cooling element by at least one coolant passage and exit the cooling element by at least another different coolant passage.

Optionally in some examples, including in at least one preferred example, the cylinder block comprises a circular beading extending inwards from the internal surface, so as to separate an upper chamber of the cooling circuit and a lower chamber of the cooling circuit, the lower chamber being closer to the lower end than the upper chamber.

A technical benefit may include ensuring that a desired flow rate of coolant reaches the upper part of the cylinder liner compared to the lower part of the cylinder liner.

Optionally in some examples, including in at least one preferred example, the cylinder liner comprises a flange, extending radially outwards from the outer surface at the upper end of the cylinder liner and the cylinder block comprises a corresponding recess, extending radially outwards from the internal surface, for receiving and positioning the cylinder liner relative to the bore of the cylinder block the flange delineating an upper axial end of the cooling circuit.

A technical benefit may include reduced cylinder deformation compared with a cylinder liner that would be clamped at its bottom or middle.

Optionally in some examples, including in at least one preferred example, the cylinder liner has a groove arranged in its outer surface, wherein a sealing ring is received inside the groove, delineating a lower axial end of the cooling circuit, the sealing ring being configured to ensure tightness to the coolant intended to flow inside the cooling circuit.

A technical benefit may include tightness of the cooling circuit at its lower axial end, thanks to the sealing ring.

Optionally in some examples, including in at least one preferred example, the cylinder assembly comprises the piston received within the cylinder liner, the piston being guided in a reciprocating translational along the cylinder axis with respect to the cylinder block, between an upper position, where the piston is at the upper end, and a lower position where the piston is closer to the lower end than the piston is in the upper position.

A technical benefit may include cooling of the piston, especially in its upper position, where the combustion occurs.

Optionally in some examples, including in at least one preferred example, the piston comprises a main body , extending around the cylinder axis and a compression ring, attached to the main body and having an annular shape coaxial with the cylinder axis, the compression ring being in contact with the inner surface of the cylinder liner, the compression ring being configured to ensure tightness to a mixture of fuel and oxidizer intended to be received between the piston and the upper end, so as to tightly separate a volume comprised between the piston and the upper end and a volume comprised between the piston and the lower end.

A technical benefit may include improving the service life of the compression ring, by cooling the compression ring, avoiding damage to the compression ring because of the heat.

Optionally in some examples, including in at least one preferred example, the cooling element extends axially, with respect to the cylinder axis, from an upmost portion of the cooling element to a lowest portion of the cooling element, the upmost portion being closer to the upper end of the cylinder liner than the lowest portion, wherein the upmost portion is located at same height, taken along the cylinder axis, as the compression ring when the piston is in the upper position.

A technical benefit may include improved cooling of the compression ring when the piston is in the upper position, because the compression ring is at same height along the cylinder axis than a part of the cooling element when the piston is in the upper position.

A second aspect of the disclosure, concerns a vehicle comprising an internal combustion engine, wherein the engine comprises a cylinder assembly as described above.

A technical benefit may include longer maintenance interval of the engine since the cylinder liners can be replaced easily and reduce thermal issues via an improved cooling.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

### BRIEF DESCRIPTION OF THE DRAWINGS

Examples are described in more detail below with reference to the appended drawings.

FIG. 1 is a schematic sectional view of an example of a cylinder assembly according to the disclosure, the piston being in the upper position.

FIG. 2 is a schematic sectional view of the cylinder assembly of FIG. 1, the piston being in the lower position.

### DETAILED DESCRIPTION

The detailed description set forth below provides information and examples of the disclosed technology with sufficient detail to enable those skilled in the art to practice the disclosure.

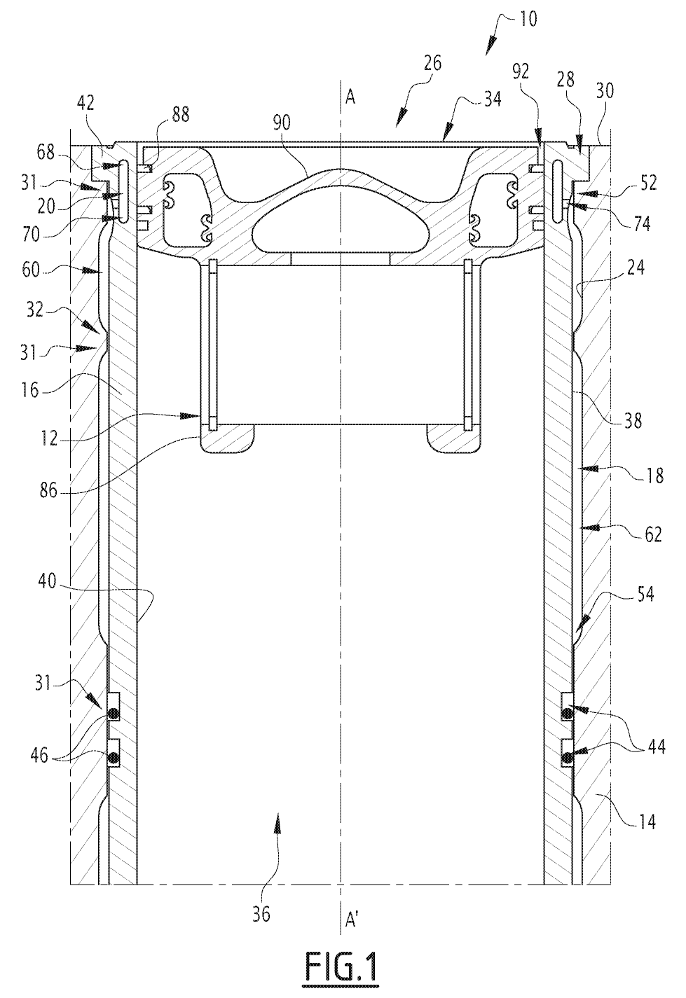

A cylinder assembly 10 for an internal combustion engine according to an example of the invention is illustrated in FIG. 1.

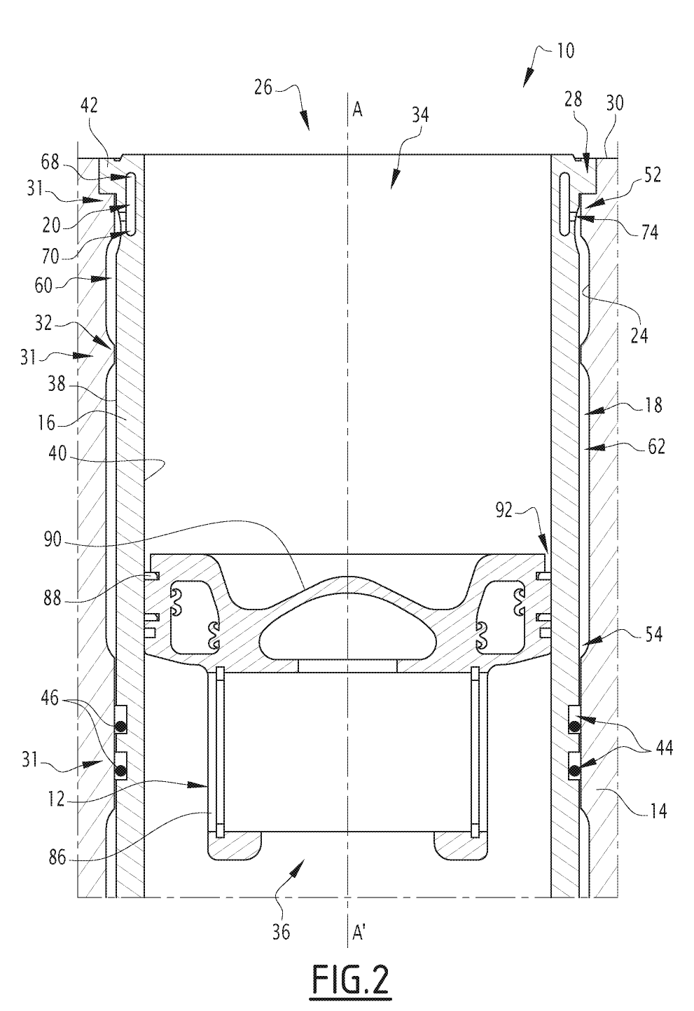

The cylinder assembly 10 is designed for guiding a piston 12 of the combustion engine in a reciprocating translation along a cylinder axis AA’ with respect to the cylinder block. The cylinder assembly 10 is configured to have the combustion of the engine occurring therein, which causes the piston 12 to move between an upper position, illustrated in FIG. 1, and a lower position, illustrated in FIG. 2. The piston 12 in turn drives in rotation a non-shown crankshaft of the engine, via a connecting rod connecting the piston 12 to the crankshaft.

The disclosure also relates to a vehicle comprising the internal combustion engine, wherein the engine comprises the cylinder assembly 10.

The cylinder assembly 10 comprises a cylinder block 14, a cylinder liner 16 received in the cylinder block 14, a cooling circuit 18 arranged between the cylinder block 14 and the cylinder liner 16, and a cooling element 20 arranged within the cylinder liner 16.

The cooling circuit 18 and cooling element 20 are intended for cooling the cylinder liner 16, which receives heat when a combustion occurs in the engine.

The cylinder block 14 comprises an internal surface 24 delineating a bore 26 centered on the cylinder axis AA’.

In a variant, the vehicle comprises a plurality of cylinder assemblies 10, wherein the plurality of cylinder assemblies 10 has a unique cylinder block 14. Then, the cylinder block has multiple internal surfaces 24, each of them delineating one bore 26.

For example, the number of bores 26 depends on the number of cylinders the internal combustion engine has.

In the example shown in the figures, the cylinder block 14 has a recess 28 that extends radially outwards from the internal surface 24 of the bore 26.

More specifically, the recess 28 has a circular shape extending around the cylinder axis AA’. Further, the recess 28 extends axially downwards from a top surface 30 of the cylinder block 14.

As can be seen, the internal surface 24 of the bore 26 has a cylindrical shape with diameter reductions 31. In particular, the cylinder block 14 has a circular beading 32 extending inwards from the internal surface 24.

The cylinder liner 16 is coaxially received in the cylinder block 14. More specifically, the cylinder liner 16 is received in the bore 26 of the cylinder block 14.

The cylinder liner 16 comprises an upper end 34 and a lower end 36, both crossed by the cylinder axis AA’, an outer surface 38, oriented radially outwards relative to the cylinder axis AA’, and an inner surface 40, oriented radially inwards relative to the cylinder axis AA’.

The inner surface 40 of the cylinder liner 16 guides the piston 12 in the reciprocating translation along the cylinder axis AA’. To this end, the inner surface 40 has a cylindrical shape extending around the cylinder axis AA’.

The outer surface 38 faces the internal surface 24 of the cylinder block 14.

In the illustrated example, the cylinder liner 16 comprises a flange 42, extending radially outward from the outer surface 38 at the upper end 34. The cylinder liner 16 is then received and positioned relative to the bore 26 by inserting the flange 42 inside the recess 28 of the cylinder block 14. The cylinder liner 16 is designed to be inserted inside the cylinder block 14 from the top surface 30.

In some example, a groove 44 of the cylinder liner 16 is arranged in the outer surface of the cylinder liner 16, for receiving a sealing ring 46. Preferably, two grooves 44 are arranged in the outer surface, preferably between the lower end 36 and the lower position of the piston 12, as can be seen on FIG. 2.

The cooling circuit 18 is delineated by the internal surface 24 of the bore 26 and the outer surface 38 of the cylinder liner 16.

The cooling circuit 18 is configured to allow a coolant to flow inside the cooling circuit 18, so that the coolant receives heat from the combustion through the cylinder liner 16.

As can be seen, the flange 42 of the cylinder liner 16 delineates an upper axial end 52 of the cooling circuit 18.

In addition, the groove 44 of the cylinder liner 16 wherein the sealing ring 46 is received, delineates a lower axial end 54 of the cooling circuit 18. The sealing ring 46 is in contact with a diameter reduction 31 of the internal surface 24.

The sealing ring 46 is configured to ensure tightness to the coolant intended to flow inside the cooling circuit 18.

The cooling circuit 18 is narrowed at some point along the cylinder axis AA’ because of the circular beading 32. Thus, the cooling circuit 18 is separated between an upper chamber 60 of the cooling circuit 18 and a lower chamber 62 of the cooling circuit 18, where the lower chamber 62 is closer to the lower end 36 than the upper chamber 60.

Preferably, a coolant supply system (not depicted) fills the cooling circuit 18 with coolant from the upper chamber 60, and the circular beading 32 provides a flow resistance to the coolant. For example, the supply system comprises a supply duct and an exhaust duct, both extending from the top surface 30 of the cylinder block to the upper chamber 60 of the cooling circuit 18.

The circular beading 32 results into a narrowing of the cooling circuit 18 that generates resistance to flow. Thus, the coolant flows more easily in the upper chamber 60 than the in the lower chamber 62, so as to efficiently cool the upper end 34 of the cylinder liner 16, which receives more heat due to the internal combustion of then engine.

Advantageously, the cooling circuit 18 has an annular shape, coaxial with the cylinder axis AA’. This allows a radially homogeneous cooling of the cylinder liner 16 between the lower axial end 54 and the upper axial end 52.

The cooling circuit 18 allows cooling of the cylinder liner 16 from the upper axial end 52 to the lower axial end 54. However, because the cylinder liner 16 is clamped to the cylinder block 14 at some height along the cylinder axis AA’, cooling of the cylinder liner 16 cannot be efficiently performed at the clamping height. In the example of the figures, clamping of the cylinder liner 16 with the cylinder block 14 is performed through the flange 42 and the recess 28, at the upper end 34.

Advantageously, as can be seen in the figures, the flange 42 protrudes above the top surface 30 to provide a gas sealing together with a cylinder head gasket (not depicted) between the cylinder liner and cylinder head (not depicted).

The cooling element 20 is arranged inside the cylinder liner 16, between the outer surface 38 and the inner surface 40. In the figures, the size of the cooling element 20 is exaggerated for visibility purpose.

Further, the cooling element 20 axially extends from an upmost portion 68 of the cooling element 20 to a lowest portion 70 of the cooling element 20, the upmost portion 68 being closer to the upper end 34 than the lowest portion 70.

The cooling element 20 is configured to provide an efficient heat transfer between the inner surface 40 of the cylinder liner 16 and the outer surface 38 of the cylinder liner 16, and between the upmost portion 68 and the lowest portion 70.

In the illustrated example, the cooling element 20 is arranged at the upper end 34 of the cylinder liner 16, to provide better cooling of the upper end 34 of the cylinder liner 16 and/or of the piston 12 when in upper position. This is advantageous since cooling of the upper end 34 by the cooling circuit 18 is relatively inefficient, for the aforementioned reasons.

Preferably, the cooling element 20 has an annular shape, coaxial with the cylinder axis AA’.

Advantageously, the lowest portion 70 of the cooling element 20 is located at same height, taken along the cylinder axis AA’, as a part of the cooling circuit 18.

In a preferred example, the cooling element 20 is a cooling gallery configured to allow a coolant to flow inside the cooling gallery. The cooling of the cylinder liner 16 is efficiently performed because of the flowing of the coolant inside the cooling element 20 that allows renewing of the coolant after it has received heat from the cylinder liner 16.

In the illustrated example, the cylinder assembly 10 comprises a coolant passage 74 connecting the cooling circuit 18 to the cooling element 20. That is, a coolant flowing inside the cooling circuit 18 also flows within the cooling element 20, passing through the coolant passage 74.

For example, the coolant passage 74 is formed inside the cylinder liner 16 and is oriented radially relative to the cylinder axis AA’.

Advantageously, an even number of coolant passages 74 is arranged inside the cylinder liner 16 and each coolant passage 74 has a corresponding coolant passage 74 opposite with respect to the cylinder axis AA’. Because there is an even number of coolant passages 74, there are pairs of coolants passages 74 acting like entries and exits for the coolant to flow in and out the cooling element 20.

For example, each pair of coolant passage 74 and corresponding coolant passages 74 are diametrically opposed, with respect to the cylinder axis AA’.

In a variant, an odd number of coolant passages 74 is provided, and the coolant passages 74 are arranged inside the cylinder liner 16. In such a variant, the combined area of the entries and the combined area of the exits are designed to avoid stagnation of the coolant in the cooling element. For example, the entries and the exits are configured so that the combined area of the entries equals the combined area of the exits.

Alternatively, the cooling element 20 comprises a solid medium having a higher thermal conductivity than the cylinder liner 16. For example, the solid medium comprises copper or sodium, whereas the cylinder liner is made of steel or iron.

In some examples, especially when the cooling element 20 comprises a solid medium, the cooling element 20 is closed and comprises no coolant passage 74 connecting it with the cooling circuit 18. The manufacturing process of a cylinder liner 16 comprising a cooling element 20 enclosed within the cylinder liner can be carried out as follows.

The first step for manufacturing the cylinder liner 16 is providing two parts of the cylinder liner, an upper liner part and a lower liner part. The upper liner part and lower liner part may be manufactured by any suitable mean, for example they may be molded, forged or additively manufactured.

Both the upper liner part and lower liner part extend around the cylinder axis AA’, the upper, respectively lower, liner part has an upper, respectively lower, connecting plane, perpendicular with the cylinder axis AA’.

Then, at least one hollow is machined within the upper connecting plane or lower connecting plane.

Optionally, for each hollow machined inside the upper, respectively lower, liner part, a corresponding hollow is machined inside the lower, respectively upper, liner part.

The hollow, and corresponding hollow if applicable, are then filled with the solid medium.

Finally, the upper connecting plane and lower connecting plane are welded together through welding, friction welding or gluing, thus forming the cylinder liner 16. The filled hollow, and filled corresponding hollow if applicable, form the cooling element 20 after the upper liner part and lower liner part have been welded together.

Advantageously, the inner surface 40 and/or outer surface 38 of the cylinder liner 16 are then grinded, to remove any weld bead resulting from the welding operation.

Optionally, the cylinder assembly comprises the piston 12. In the upper position, the piston 12 is at the upper end 34 of the liner, as illustrated in FIG. 1, in the lower position, the piston 12 is closer to the lower end 36 than the piston 12 is in the upper position, as illustrated in FIG. 2.

The piston 12 comprises a main body 86, extending around the cylinder axis AA’, and a compression ring 88 attached to the main body 86 and having an annular shape, coaxial with the cylinder liner AA’.

The main body 86 comprises a push surface 90, axially close to the upper end 34 of the cylinder liner 16. The push surface 90 is designed to be in contact with a mixture of fuel and oxidizer received between the piston 12 and the upper end 34, and to receive energy from the combustion in order to move the piston 12.

The compression ring 88 is in contact with the inner surface 40 of the cylinder liner 16, and is configured to ensure tightness to the mixture of fuel and oxidizer. The compression ring 88 tightly separates the volume comprised between the piston 12 and the upper end 34 and the volume comprised between the piston 12 and the lower end 36.

There is a gap 92 between the compression ring 88 and the push surface 90, the schematic representation of the gap 92 is exaggerated to make it visible on the figures. During operation of the engine, the gap 92 is filled with the mixture and the mixture therein is not burnt when the piston arrives at the upper position. Then, it leads to a waste of fuel and a potential unwanted combustion may occur at an uncertain moment.

The compression ring 88 is sensitive to overheating, which can damage the compression ring 88, thus reducing its service life and tightness.

As can be seen on FIG. 1, when the piston 12 is in its upper position, the upmost portion 68 of the cooling element 20 is located at same height, taken along the cylinder axis AA’, as the compression ring 88. This allows cooling of the cylinder liner 16 further toward the upper end 34 than the cooling circuit 18. Then, it is possible to cool the compression ring 88 located closer to the upper end 34 than what the prior art discloses.

During the operation of the cylinder assembly 10, the piston 12 moves back and forth in the reciprocating translation along the cylinder axis AA’. The movement of the piston 12 is caused by the periodic repetition of the injection of the mixture, its compression and combustion, and its exhaustion.

The coolant is supplied in the cylinder block 14, inside the upper chamber 60 of the cooling circuit 18.

The coolant spreads in the cooling circuit 18, and flows inside the cooling circuit 18, around the cylinder axis AA’.

When the coolant flows inside the cooling circuit 18, the coolant is able to reach the coolant passage 74, and enters the cooling element 20.

The cooling circuit 18 ensures cooling of the cylinder liner 16 between the upper axial end 52 and the lower axial end 54, radially extracting heat from the inner surface 40 of the cylinder liner 16 to the coolant.

Because of the cooling element 20, the coolant is able to access further toward the upper end 34 than the upper axial end 52 of the cooling circuit 18. Thus, a cooling of the upper part 34 of the liner, especially the flange 42, is efficiently performed.

In addition, when the piston 12 is in its upper position, the compression ring 88 is cooled because it is located at same height as the cooling element 20, thus transmitting heat to the cooling element 20 through the cylinder liner 16.

The coolant circulates inside the cooling element 20, toward a corresponding coolant passage 74, acting like an exit for the coolant. Thus, after circulating around the upper end 34, the coolant flows back into the cooling circuit 18, and then leaves the cooling circuit 18 through an exit of the coolant supply system.

The cylinder assembly according to the disclosure allows arranging the compression ring 88 closer to the push surface 90 of the piston 12, which reduces the size of the gap 92, therefore reducing fuel waste and unwanted combustion than with a cylinder assembly 10 according to the prior art.

Moreover, the flange 42 is radially cooled by the cooling element 20, partially in contact with the cooling circuit 18, preventing hotspots from forming on the flange 42.

Example 1: A cylinder assembly 10, for an internal combustion engine, comprising:
a cylinder block 14, comprising an internal surface 24 delineating a bore 26 centered on a cylinder axis AA’,
a cylinder liner 16, coaxially received in the cylinder block and comprising an upper end 34, crossed by the cylinder axis AA’, a lower end 36, crossed by the cylinder axis AA’, an outer surface 38, oriented radially outwards relative to the cylinder axis AA’ so as to face the internal surface 24 of the cylinder block 14, and an inner surface 40, oriented radially inwards to guide a piston 12 in a reciprocating translation along the cylinder axis AA’, with respect to the cylinder block 14, between the upper end 34 and the lower end 36,
a cooling element 20, arranged inside the cylinder liner 16, between the outer surface 38 and the inner surface 40, and
a cooling circuit 18, delineated by the internal surface 24 of the bore 26 and the outer surface 38 of the cylinder liner 16, the cooling circuit 18 being configured to allow a coolant to flow inside the cooling circuit 18.

Example 2: The cylinder assembly 10 of example 1, wherein the cooling circuit 18 has an annular shape, coaxial with the cylinder axis AA’.

Example 3: The cylinder assembly 10 of example 1 or 2, wherein the cooling element 20 is located at the upper end 34 of the cylinder liner 16.

Example 4: The cylinder assembly 10 of any of examples 1 to 3, wherein the cooling element 20 has an annular shape, coaxial with the cylinder axis AA’.

Example 5: The cylinder assembly 10 of any of examples 1 to 4, wherein the cooling element 20 extends axially, with respect to the cylinder axis AA’, from an upmost portion 68 of the cooling element 20 to a lowest portion 70 of the cooling element 20, the upmost portion 68 being closer to the upper end 34 of the cylinder liner 16 than the lowest portion 70, wherein the lowest portion 70 is located at same height, taken along the cylinder axis AA’, as a part of the cooling circuit 18.

Example 6: The cylinder assembly 10 of any of examples 1 to 5, wherein the cooling element 20 is a cooling gallery configured to allow a coolant to flow inside.

Example 7: The cylinder assembly 10 of any of examples 5 or 6, wherein the cylinder assembly 10 comprises a coolant passage 74 connecting the cooling circuit 18 to the cooling element 20

Example 8: The coolant passage 74 is preferably formed in the cylinder liner 16 and oriented radially relative to the cylinder axis AA’.

Example 9: The cylinder assembly 10 of example 7 or 8, comprising an even number of coolant passages 74, each coolant passage 74 having a corresponding coolant passage 74 opposite with respect to the cylinder axis AA’.

Example 10: The cylinder assembly 10 of any of examples 1 to 5, wherein the cooling element 20 comprises a solid medium.

Example 11: The cylinder assembly 10 of example 10, wherein the solid medium has a higher thermal conductivity than the cylinder liner 16.

Example 12: The cylinder assembly 10 of any of examples 1 to 11, wherein the cylinder block 14 comprises a circular beading 32 extending inwards from the internal surface 24, so as to separate an upper chamber 60 of the cooling circuit 18 and a lower chamber 62 of the cooling circuit 18, the lower chamber 62 being closer to the lower end 36 than the upper chamber 60.

Example 13: The cylinder assembly 10 of any of examples 1 to 12, wherein the cylinder liner 16 comprises a flange 42, extending radially outwards from the outer surface 38 at the upper end 34 of the cylinder liner 16 and the cylinder block 14 comprises a corresponding recess 28, extending radially outwards from the internal surface 24, for receiving and positioning the cylinder liner 16 relative to the bore 26 of the cylinder block 14, the flange 42 delineating an upper axial end 52 of the cooling circuit 18.

Example 14: The cylinder assembly 10 of any of examples 1 to 13, wherein the cylinder liner 16 has a groove 44 arranged in its outer surface 38, wherein a sealing ring 46 is received inside the groove 44, delineating a lower axial end 54 of the cooling circuit 18, the sealing ring 46 being configured to ensure tightness to the coolant intended to flow inside the cooling circuit 18.

Example 15: The cylinder assembly 10 of any of examples 12 to 14, comprising a coolant supply system for filling the cooling circuit 18 with a coolant from the upper chamber 60.

Example 16: The cylinder assembly 10 of any of examples 1 to 15, comprising the piston 12 received within the cylinder liner 16, the piston 12 being guided in a reciprocating translational along the cylinder axis AA’ with respect to the cylinder block 14, between an upper position, where the piston 12 is at the upper end 34, and a lower position where the piston 12 is closer to the lower end 36 than the piston 12 is in the upper position.

Example 17: The cylinder assembly 10 of example 16, wherein the piston 12 comprises a main body 86, extending around the cylinder axis AA’ and a compression ring 88, attached to the main body 86 and having an annular shape coaxial with the cylinder axis AA’, the compression ring 88 being in contact with the inner surface 40 of the cylinder liner 16, the compression ring 88 being configured to ensure tightness to a mixture of fuel and oxidizer intended to be received between the piston 12 and the upper end 34, so as to tightly separate a volume comprised between the piston 12 and the upper end 34 and a volume comprised between the piston 12 and the lower end 36.

Example 18: The cylinder assembly 10 of example 17, wherein the cooling element 20 extends axially, with respect to the cylinder axis AA’, from an upmost portion 68 of the cooling element 20 to a lowest portion 70 of the cooling element 20, the upmost portion 68 being closer to the upper end 34 of the cylinder liner 16 than the lowest portion 70, wherein the upmost portion 68 is located at same height, taken along the cylinder axis AA’, as the compression ring 88 when the piston 12 is in the upper position.

Example 19: A vehicle comprising an internal combustion engine, wherein the engine comprises a cylinder assembly 10 according to any of examples 1 to 18.

Example 20: the vehicle of example 19, comprising a plurality of cylinder assemblies 10, wherein the plurality of cylinder assemblies 10 has a unique cylinder block 14, the cylinder block 14 having multiple internal surfaces 24, each of them delineating one bore 26.

The terminology used herein is for the purpose of describing particular aspects only and is not intended to be limiting of the disclosure. As used herein, the singular forms "a," "an," and "the" are intended to include the plural forms as well, unless the context clearly indicates otherwise. As used herein, the term "and/or" includes any and all combinations of one or more of the associated listed items. It will be further understood that the terms "comprises," "comprising," "includes," and/or "including" when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as "below" or "above" or "upper" or "lower" or "horizontal" or "vertical" may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being "connected" or "coupled" to another element, it can be directly connected or coupled to the other element, or intervening elements may be present. In contrast, when an element is referred to as being "directly connected" or "directly coupled" to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. A cylinder assembly, for an internal combustion engine, comprising:
a cylinder block, comprising an internal surface delineating a bore centered on a cylinder axis,
a cylinder liner, coaxially received in the cylinder block and comprising an upper end, crossed by the cylinder axis, a lower end, crossed by the cylinder axis, an outer surface, oriented radially outwards relative to the cylinder axis so as to face the internal surface of the cylinder block, and an inner surface, oriented radially inwards to guide a piston in a reciprocating translation along the cylinder axis, with respect to the cylinder block, between the upper end and the lower end,
a cooling element, arranged inside the cylinder liner, between the outer surface and the inner surface, and
a cooling circuit, delineated by the internal surface of the bore and the outer surface of the cylinder liner, the cooling circuit being configured to allow a coolant to flow inside the cooling circuit,
wherein the cooling element extends axially, with respect to the cylinder axis, from an upmost portion of the cooling element to a lowest portion of the cooling element, the upmost portion being closer to the upper end of the cylinder liner than the lowest portion, wherein the lowest portion is located at same height, taken along the cylinder axis, as a part of the cooling circuit,
wherein the cylinder assembly comprises a coolant passage connecting the cooling circuit to the cooling element and wherein the coolant passage is formed in the cylinder liner and oriented radially relative to the cylinder axis.

2. The cylinder assembly of claim 1, wherein the cooling circuit has an annular shape, coaxial with the cylinder axis.

3. The cylinder assembly of claim 1, wherein the cooling element is located at the upper end of the cylinder liner.

4. The cylinder assembly of claim 1, wherein the cooling element has an annular shape, coaxial with the cylinder axis.

5. The cylinder assembly of claim 1, wherein the cooling element is a cooling gallery configured to allow a coolant to flow inside.

6. The cylinder assembly of claim 1, comprising an even number of coolant passages, each coolant passage having corresponding coolant passage opposite with respect to the cylinder axis.

7. The cylinder assembly of claim 1, wherein the cylinder block comprises a circular beading extending inwards from the internal surface, so as to separate an upper chamber of the cooling circuit and a lower chamber of the cooling circuit, the lower chamber being closer to the lower end than the upper chamber.

8. The cylinder assembly of claim 1, wherein the cylinder liner comprises a flange, extending radially outwards from the outer surface at the upper end of the cylinder liner and the cylinder block comprises a corresponding recess, extending radially outwards from the internal surface, for receiving and positioning the cylinder liner relative to the bore of the cylinder block, the flange delineating an upper axial end of the cooling circuit.

9. The cylinder assembly of claim 1, wherein the cylinder liner has a groove arranged in its outer surface, wherein a sealing ring is received inside the groove, delineating a lower axial end of the cooling circuit, the sealing ring being configured to ensure tightness to the coolant intended to flow inside the cooling circuit.

10. The cylinder assembly of claim 1, comprising the piston received within the cylinder liner, the piston being guided in a reciprocating translational along the cylinder axis with respect to the cylinder block, between an upper position, where the piston is at the upper end, and a lower position where the piston is closer to the lower end than the piston is in the upper position.

11. The cylinder assembly of claim 10, wherein the piston comprises a main body, extending around the cylinder axis and a compression ring, attached to the main body and having an annular shape coaxial with the cylinder axis, the compression ring being in contact with the inner surface of the cylinder liner, the compression ring being configured to ensure tightness to a mixture of fuel and oxidizer intended to be received between the piston and the upper end, so as to tightly separate a volume comprised between the piston and the upper end and a volume comprised between the piston and the lower end.

12. The cylinder assembly of claim 1, wherein the cooling element extends axially, with respect to the cylinder axis, from an upmost portion of the cooling element to a lowest portion of the cooling element, the upmost portion being closer to the upper end of the cylinder liner than the lowest portion, wherein the upmost portion is located at same height, taken along the cylinder axis, as the compression ring when the piston is in the upper position.

13. A vehicle comprising an internal combustion engine, wherein the engine comprises a cylinder assembly according to claim 1.
